(19) United States
(12) Patent Application Publication
(10) Pub. No.: US 2010/0263177 A1
(43) Pub. Date: Oct. 21, 2010

(54) Folding Casket

(76) Inventors: Ayberk Abayhan, Lake Bluff, IL (US); Yeldrim Baycora, Venice, FL (US); Ibrahim Michael Baycora, Wyckoff, NJ (US)

Correspondence Address: Ayberk Abayhan, 917 West Woodland Rd., Lake Bluff, IL, 60044, US

(21) Appl. No.: 12/758,176

(22) Filed: Apr. 12, 2010

Related U.S. Application Data
(60) Provisional application No. 61/169,678, filed on Apr. 15, 2009.

(51) Int. Cl. A61G 17/013; A61G 17/007

(52) U.S. Cl. 27/4; 27/6; 27/7

(57) ABSTRACT

A casket can be folded and stacked into a flat position wherein multiple caskets can be stacked for efficient storage and transportation. The casket comprises a plurality of panels which have grooves which are engaged by respective panels and/or engage grooves in respective panels. Two side panels are hinged to a bottom panel and are engaged by and automatically align with the bottom panel when unfolded to a vertical position. The casket can be quickly and easily assembled with minimal exertion into a rigid casket by one person with minimal hardware.

### RELATED APPLICATIONS

This application claims priority to Provisional Patent Application No. 61/169,678 filed Apr. 15, 2009 titled Folding Casket and is incorporated herein by reference.

### FIELD OF THE INVENTION

The present invention relates to caskets and more particularly to a folding and stackable casket which can be quickly assembled into a rigid structure by one person with minimal hardware.

### BACKGROUND

There are several caskets in the prior art which are collapsible and/or foldable. These two features save cost by allowing for more efficient transportation throughout the entire distribution channel, from the manufacturer to the final place of need. Caskets in a folded or collapsed state which can be stacked upon one another during this transportation will take up less room in the means of transportation, thus saving costs. Caskets in a folded or collapsed state will also take up less space at the manufacturer's facility when being stored prior to shipping as well as when stored throughout the distribution channel, thus also saving costs.

An example of a collapsible casket is shown in U.S. Pat. No. 6,314,626 issued to Becker. This patent discloses a casket wherein its parts can be stored within the lid for transportation and storage. When the casket is needed, the side walls and other parts are assembled using screws and corner brackets. The corner brackets on respective walls interlock and twenty screws secure the side walls, end walls, bottom, and lid together when assembled. The '626 patent attempts to introduce a casket which can be assembled by an unskilled person in a few minutes with simple hand tools. It would be assumed that the simple hand tool needed in this case would be a screw driver because wood screws are called out as the preferred fastener. Although the side walls, the end walls, the bottom, and the top lid all have predrilled holes for the wood screws, it would require much physical exertion to hold and align the walls with one another with one hand while using the other hand to screw the screws with a screw driver. Using an electric or cordless drill would be just as awkward for just one person. Having to screw twenty screws to complete the assembly of the casket would not only require much physical exertion, it would also require a fair amount of time. If nails or staples were the preferred fastener, one person assembling this casket would face the same issues. If fewer fasteners were used to save assembly time, the structural integrity and strength of the bottom planar member position would be sacrificed. The fasteners are what hold the bottom planar member in position when fully assembled. Thus, there still remains a need for a casket which can be folded and stacked for efficient storage and transportation and can be quickly and easily assembled into a rigid structure by one person at the time of need.

### SUMMARY

The present invention is directed to a casket wherein the components can be folded and/or stacked upon each other into a flat state, thus allowing multiple caskets to be stacked upon one another for more efficient storage and transportation. The casket can also be quickly and easily assembled into a rigid structure by one person at the time of need. The casket comprises a bottom panel, two side panels, two end panels, and a top panel. In the preferred embodiment, the first side panel and the second side panel each have a horizontal groove near their respective bottoms for engagement by the bottom panel. Both end panels have a vertical groove on both ends which are engaged by respective side panels. A respective bolt and threaded insert secure each side panel end with a respective end panel end. The top panel has a groove around its perimeter on one side and is engaged by the side panels and the end panels and is secured by latches which are attached to the side panels. All of the panels have grooves which are engaged by respective panels and/or engage grooves in respective panels. This type of fit provides continuous support and strength to the casket when assembled.

In another aspect of the invention, the two side panels are hinged to the bottom panel wherein one side panel can fold down and lay flat on the bottom panel. A second side panel can fold down and lay flat on the first side panel. To start the assembly of the casket, each side panel can be folded to a vertical position wherein the above mentioned horizontal groove of the side panels automatically align with and are engaged by the bottom panel. This aspect of the invention allows these three panels of the casket to lay flat to provide efficient storage and transportation; provides a bottom panel that is continuously secured and engaged along its length with the two side panels, thus providing strength; and provides an extremely easy and fast way for one person to begin the assembly of the casket.

Other aspects of the invention will become apparent in the detailed description.

### BRIEF DESCRIPTION OF THE DRAWINGS

FIG. 1 is a front view illustrating the preferred embodiment wherein the bottom panel, the side panels, the end panels, and the top panel are all laying flat on top of one another in a folded state.

FIG. 2 is a perspective view illustrating the preferred embodiment wherein the bottom panel, the side panels, the end panels, and the top panel are all laying flat on top of one another in a folded state.

FIG. 3 is an exploded view illustrating the preferred embodiment wherein the bottom panel, the side panels, the end panels, and the top panel are all laying flat on top of one another in a folded state.

FIG. 4 is a perspective view illustrating a preferred embodiment of a bottom panel with two hinges attached.

FIG. 5 is a perspective view illustrating a preferred embodiment of a first side panel including a detail view of one end.

FIG. 6 is a perspective view illustrating a preferred embodiment of a second side panel including a detail view of one end.

FIG. 7 is a perspective view illustrating a preferred embodiment of an end panel.

FIG. 8 is a perspective view illustrating a preferred embodiment of a top panel.

FIG. 9 is a perspective view illustrating a preferred embodiment of a first side panel folded flat on top of a bottom panel and a second side panel folded flat on top of the first side panel.

FIG. 10 is a perspective view illustrating a preferred embodiment of a first side panel and a second side panel hinged to a bottom panel and partially unfolded upward.

FIG. 11 is a perspective view illustrating a preferred embodiment of a first side panel and a second side panel hinged to a bottom panel and unfolded to vertical positions.

FIG. 12 is an exploded perspective view illustrating a preferred embodiment of the casket according to the present invention.

FIG. 13 is a perspective view illustrating a preferred embodiment of the casket according to the present invention fully assembled.

### DETAILED DESCRIPTION

The preferred embodiment illustrated in the drawings is for a folding casket which can be quickly and easily assembled by one person into a rigid casket. Referring now to the drawings, the preferred embodiment of the folding casket according to the present invention will be described and indicated generally by the numeral 10. The folding casket 10 comprises a bottom panel 20, a first side panel 30, a second side panel 40, two end panels 50, a top panel 60, and hardware 70, 71, 72, 73, and 74.

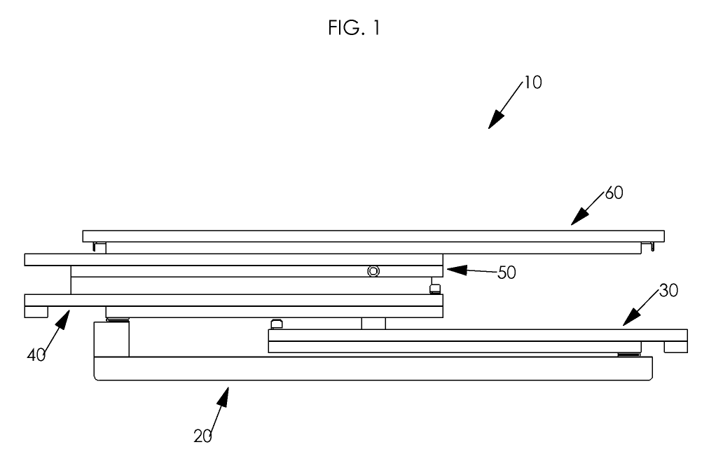

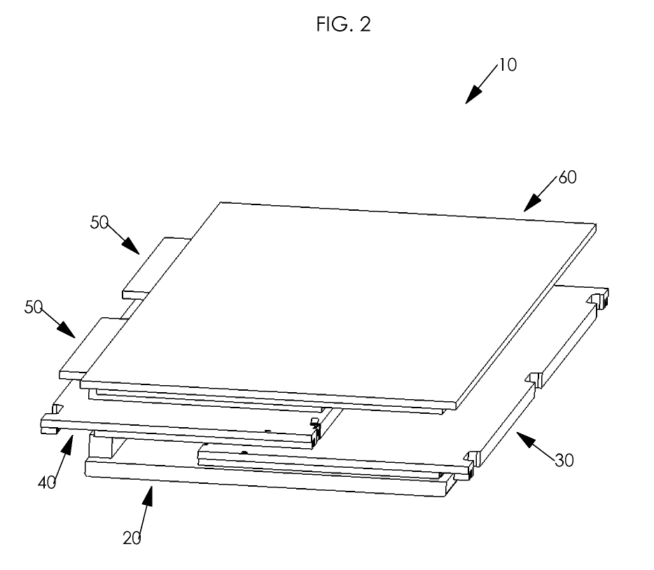

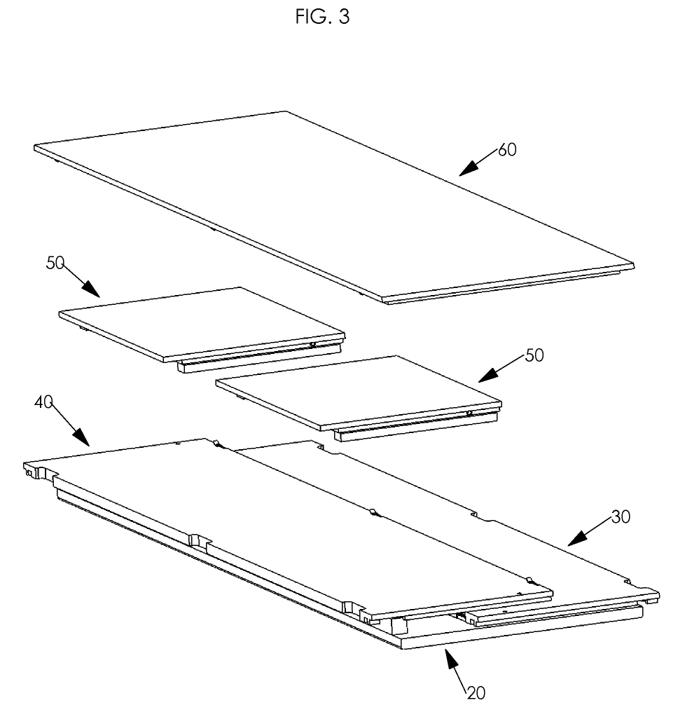

FIG. 1 illustrates folding casket 10 folded and stacked into a flat position. The first side panel 30 is folded down on top of bottom panel 20. The second side panel 40 is folded down on top of the first side panel 30. End panels 50 are stacked on top of the second side panel 40. Top panel 60 is stacked on top of end panels 50. When folded and stacked in this flat position, multiple folding caskets 10 can be stacked on top of one another for more efficient transportation and storage. FIG. 2 is a perspective view illustrating folding casket 10 folded and stacked into a flat position. FIG. 3 is a perspective exploded view illustrating folding casket 10 folded and stacked into a flat position. The components of the folding casket 10 will be described in more detail below along with the procedure for quick and easy assembly from the above mentioned folded and stacked position to a rigid casket.

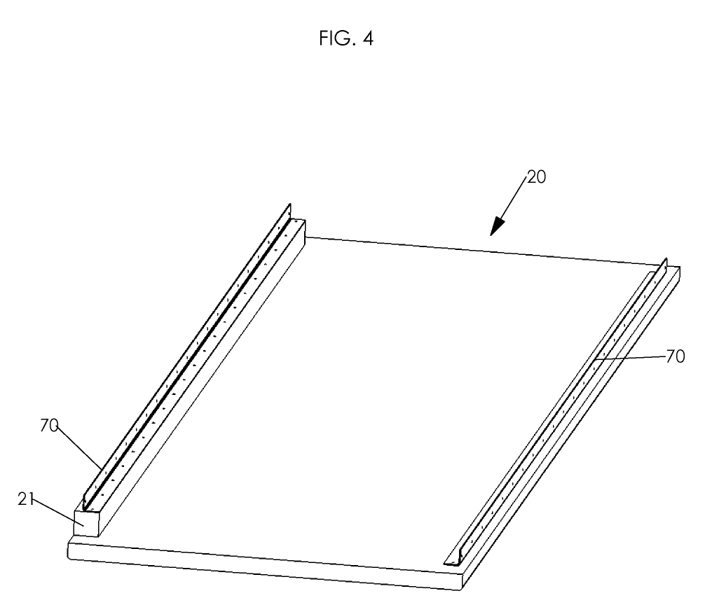

The bottom panel 20 is best illustrated in FIG. 4. In the preferred embodiment, the bottom panel 20 is generally a rectangular flat surface except for a raised section 21 along one of its long sides. A hinge 70 is mounted on top of this raised section 21 of bottom panel 20. A hinge 70 is also mounted on top of bottom panel 20 at an opposing end on the same side.

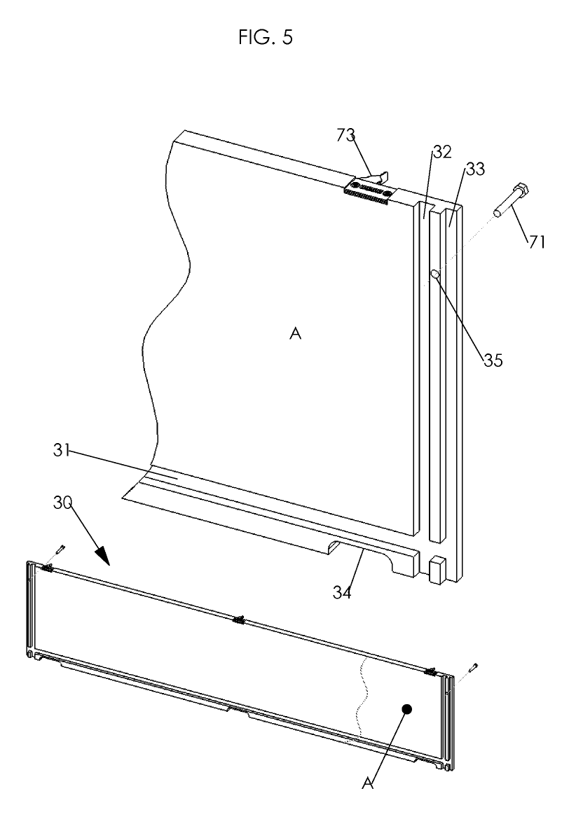

The first side panel 30 is best illustrated in FIG. 5. In the preferred embodiment, the first side panel 30 is generally rectangular in shape and includes a horizontal groove 31 near the bottom and vertical grooves 32 and 33 at both ends. A plurality of latches 73 are attached to the top and a plurality of grooves 34 are formed at the bottom. Aperture 35 is formed to receive bolt 71.

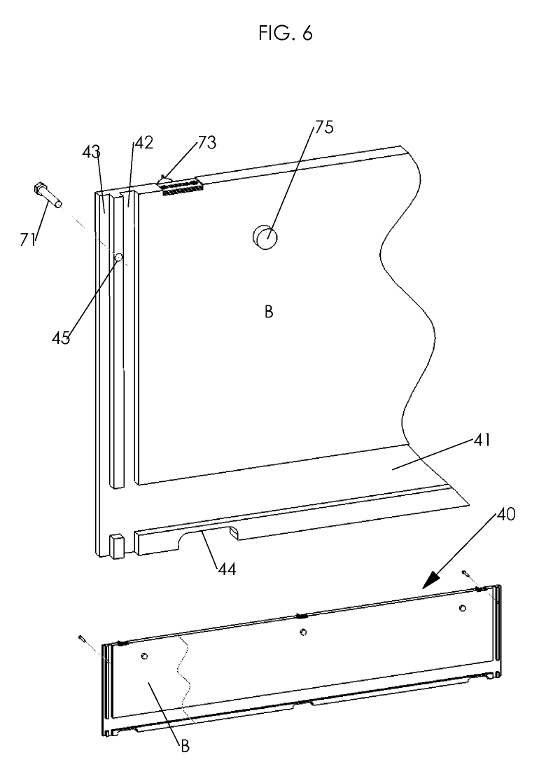

The second side panel 40 is best illustrated in FIG. 6. In the preferred embodiment, the second side panel 40 is generally rectangular in shape and includes a horizontal groove 41 near the bottom and vertical grooves 42 and 43 at both ends. A plurality of latches 73 are attached to the top and a plurality of grooves 44 are formed at the bottom. Aperture 45 is formed to receive bolt 71. Bumpers 75 are attached to second side panel 40.

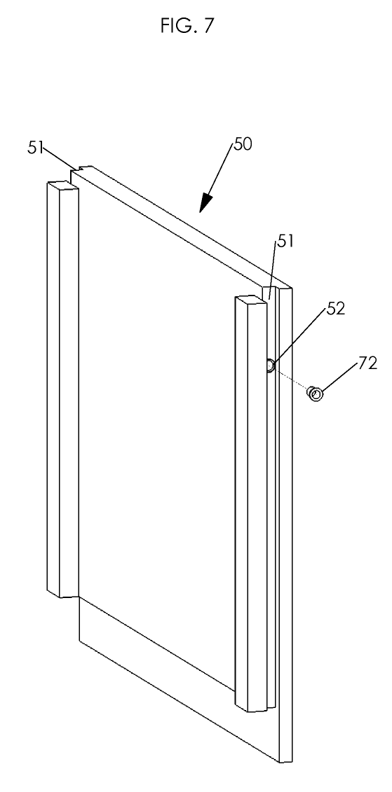

An end panel 50 is best illustrated in FIG. 7. In the preferred embodiment, an end panel 50 is generally rectangular in shape and includes vertical grooves 51 at both ends. Aperture 52 is formed to receive threaded bolt insert 72.

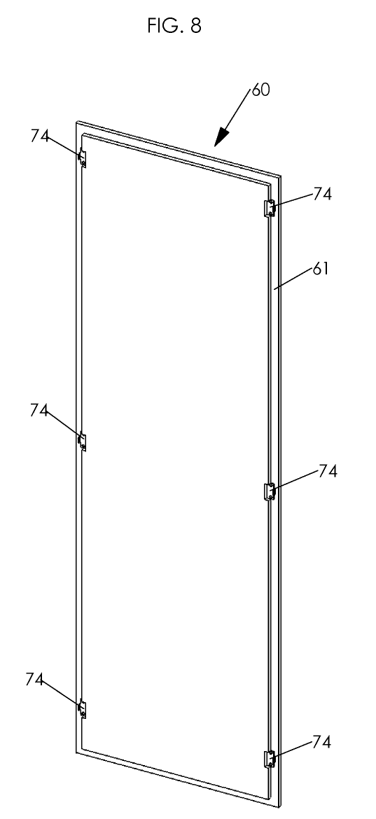

The top panel 60 is best illustrated in FIG. 8. In the preferred embodiment, the top panel 60 is generally rectangular in shape and includes a groove 61 around the edge of the perimeter on one side. A plurality of latch receivers 74 are attached to the top panel 60 on groove 61.

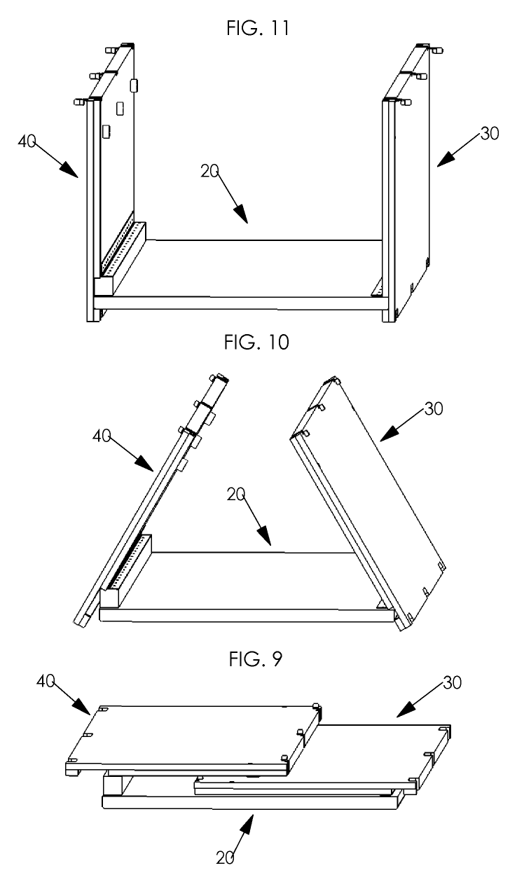

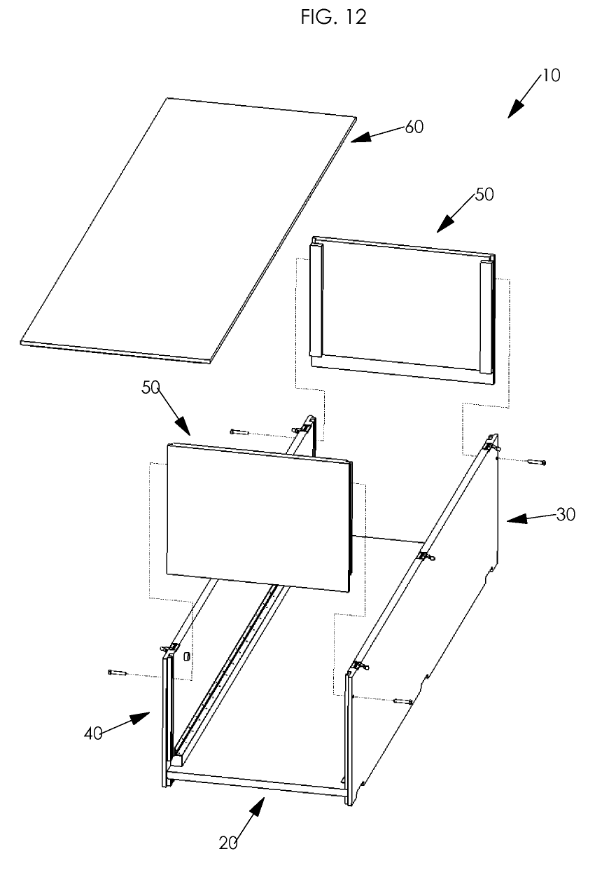

FIGS. 9, 10, and 11 illustrate the beginning steps to assembling folding casket 10. As illustrated in FIG. 9, first side panel 30 is folded down flat and is resting on bottom panel 20. Second side panel 40 is folded down flat wherein bumpers 75 rest on first side panel 30. Since hinges 70 are offset, second side panel 40 is able to lay flat. As best illustrated in FIGS. 10 and 11, first side panel 30 and second side panel 40 are attached to hinges 70 and are folded upward to begin the assembly of folding casket 10. First side panel 30 is attached to bottom panel 20 wherein groove 31 of first side panel 30 is engaged by bottom panel 20 as it is folded upward. The person assembling folding casket 10 does not have to spend any time aligning bottom side panel 20 with first side panel 30 as this is done automatically. Second side panel 40 is attached to bottom panel 20 wherein groove 41 of second side panel 40 is engaged by bottom panel 20 as it is folded upward. The person assembling folding casket 10 does not have to spend any time aligning bottom side panel 20 with second side panel 40 as this is done automatically.

After first side panel 30 and second side panel 40 are unfolded into vertical positions, as illustrated in FIG. 12, end panels 50 slide into first side panel 30 and second side panel 40 wherein end panels 50 engage respective grooves 32 and 33 in first side panel 30 and respective grooves 42 and 43 in second side panel 40. Also, first side panel 30 and second side panel 40 engage respective grooves 51 in end panels 50. As in the first step of assembly, minimal time or exertion is spent in the second step of assembly when sliding end panels 50 into position. The third step is to secure first side panel 30 and second side panel 40 to end panels 50 with bolts 71. A simple hand wrench can be used to tighten bolts 71 into threaded bolt inserts 72. Once again, this third step of assembly can be done very quickly with minimal exertion.

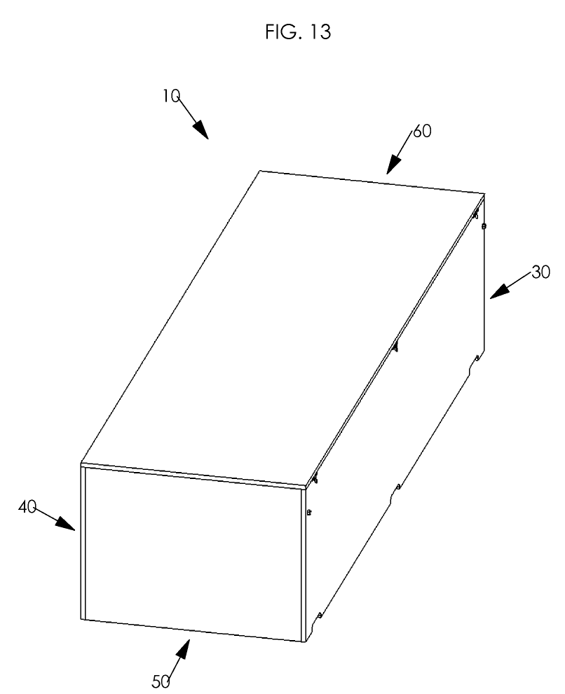

The fourth step of assembly, as best illustrated in FIG. 12, is to place top panel 60 on top of and wherein first side panel 30, second side panel 40, and end panels 50 engage groove 61. Latches 73 can be closed and locked into respective latch receivers 74. This completes the assembly of step 4 as well as the assembly of folding casket 10 as illustrated in FIG. 13. All four steps of assembly can be done very quickly and with minimal exertion by one person. The above mentioned bolts 71, threaded bolt inserts 72, latches 73, and latch receivers 74 as well as the panels having grooves which are engaged by respective panels and/or engage grooves in respective panels provide a very rigid casket when assembled. This type of fit also provides continuous support along the panels, thus giving strength to the casket when assembled. Grooves 34 and 44 provide areas for hand placement to carry fully assembled folding casket 10.

Those skilled in the art would understand that other types of hardware could be used to fasten the panels such as nails or screws. In the preferred embodiment, folding casket 10 is made of wood. Those skilled in the art would understand that folding casket 10 could be made from some other suitable material such as hollow wood, plastic, or metal.

The present invention may of, of course, be carried out in other specific ways than those herein set forth without departing from the scope of the present invention. The present embodiments are, therefore, to be considered in all respects as illustrative and not restrictive, and all changes made by others coming within the meaning and equivalency range of the appended claims are intended to be embraced therein.

What is claimed is:

1. A foldable casket comprising:
a bottom panel to form the bottom of said foldable casket;
a first side panel to form one side of said foldable casket and a second side panel to form a second side of said foldable casket, said first side panel and said second side panel pivotally attached to said bottom panel;
a first end panel and a second end panel to form opposing ends of said foldable casket;
a top panel to form top of said foldable casket; and
wherein said first side panel and said second side panel each include a groove that aligns with and engages said bottom panel when said first side panel and said second side panel are pivotally adjusted and disposed in respective upright positions.

2. The foldable casket of claim 1 wherein said first side panel is pivotally attached to a first portion of said bottom panel and said second side panel is pivotally attached to a second portion of said bottom panel, and wherein said first portion is higher than said second portion.

3. The foldable casket of claim 2 wherein said second side panel is pivotally adjustable to a rest position on top of and generally parallel with said bottom panel and said first side panel is pivotally adjustable to a rest position on top of and generally parallel with said second side panel.

4. The foldable casket of claim 1 wherein said respective grooves span the entire length of said first side panel and said second side panel.

5. The foldable casket of claim 3 wherein said groove in said first side panel and said groove in said second side panel support the entire length of said bottom panel when said first side panel and said second side panel are pivotally adjusted and disposed in respective upright positions.

6. The foldable casket of claim 1 further including at least two hinges wherein a first hinge is coupled to said bottom panel and said first side panel and a second hinge is coupled to said bottom panel and said second side panel.

7. The foldable casket of claim 6 wherein said hinges are metal.

8. The foldable casket of claim 6 wherein said hinges are plastic.

9. The foldable casket of claim 1 wherein said first side panel and said second side panel each include respective second and third grooves for aligning and engaging with said first end panel and said second end panel when said first side panel and said second side panel are pivotally adjusted and disposed in respective upright positions.

10. The foldable casket of claim 9 wherein said first end panel and said second end panel each include a threaded insert on opposing sides, said first side panel and said second side panel each include at least two holes, and wherein said foldable casket further includes at least four bolts to pass through respective said holes, to thread into said threaded inserts, and to secure said first end panel and said second end panel to said first side panel and said second side panel.

11. The foldable casket of claim 1 wherein said first end panel and said second end panel each include a groove on opposing sides for aligning and engaging with said first side panel and said second side panel when said first side panel and said second side panel are pivotally adjusted and disposed in respective upright positions.

12. The foldable casket of claim 11 wherein said first end panel and said second end panel each include a threaded insert on opposing sides, said first side panel and said second side panel each include at least two holes, and wherein said foldable casket further includes at least four bolts to pass through respective said holes, to thread into said threaded inserts, and to secure said first end panel and said second end panel to said first side panel and said second side panel.

13. The foldable casket of claim 1 wherein said top panel includes a groove around its perimeter on one side to align with and engage said first side panel, said second side panel, said first end panel, and said second end panel.

14. The foldable casket of claim 13 wherein said top panel includes at least four latches, said first side panel includes at least two latch receivers, and said second side panel includes at least two latch receivers, and wherein said latches lock into said latch receivers to secure said top panel to said first side panel, said second side panel, said first end panel, and said second end panel.

15. The foldable casket of claim 1 wherein said first side panel and said second side panel each include at least two grooves for grasping when carrying said foldable casket.

16. The foldable casket of claim 1 wherein said bottom panel, said first side panel, said second side panel, said first end panel, said second end panel, and said top panel are made of wood.

17. A foldable casket comprising:
a bottom panel to form the bottom of said foldable casket;
a first side panel to form one side of said foldable casket and a second side panel to form a second side of said foldable casket, said first side panel and said second side panel pivotally attached to said bottom panel;
a first end panel and a second end panel to form opposing ends of said foldable casket;
a top panel to form top of said foldable casket; and
wherein said first side panel and said second side panel align with and engage respective grooves on said bottom panel when said first side panel and said second side panel are pivotally adjusted and disposed in respective upright positions.

18. The foldable casket of claim 17 wherein said first side panel is pivotally attached to a first portion of said bottom panel and said second side panel is pivotally attached to a second portion of said bottom panel, and wherein said first portion is higher than said second portion.

19. The foldable casket of claim 18 wherein said second side panel is pivotally adjustable to a rest position on top of and generally parallel with said bottom panel and said first side panel is pivotally adjustable to a rest position on top of and generally parallel with said second side panel.

20. The foldable casket of claim 17 wherein said grooves span the entire length of said bottom panel.
